(19) United States
(12) Patent Application Publication
(10) Pub. No.: US 2025/0332648 A1
(43) Pub. Date: Oct. 30, 2025

(54) SCRAP CUTTING SYSTEM WITH MOVEABLE ENCLOSURE

(71) Applicant: Edw. C. Levy Co., Detroit, MI (US)

(72) Inventors: John Robert Schwarz, Southgate, MI (US); Katie Nicole Davis, Royal Oak, MI (US); Arturo Michael Olvera, St. John, IN (US); Jason Lowell Millard, LaPorte, IN (US); Olivier Arnes, Tarare (FR)

(73) Assignee: Edw. C. Levy Co., Detroit, MI (US)

(21) Appl. No.: 19/187,154

(22) Filed: Apr. 23, 2025

Related U.S. Application Data
(60) Provisional application No. 63/638,770, filed on Apr. 25, 2024.

(51) Int. Cl. B23D 31/00; B23D 33/02

(52) U.S. Cl. CPC B23D 31/008; B23D 33/02

(57) ABSTRACT

A scrap cutting system includes an enclosure having a first side wall, an opposite second side wall, a first end wall, and an opposite second end wall cooperating to define an interior chamber. The scrap cutting system includes a carriage system supporting the enclosure and configured to translate along a track system, and a multi-axis cutting assembly received within the interior chamber of the enclosure. The scrap cutting system further includes an air treatment assembly attached to the enclosure and including at least one intake in fluid communication with the interior chamber.

### CROSS REFERENCE TO RELATED APPLICATIONS

This application claims priority under 35 U.S.C. § 119 (e) to U.S. Provisional Application 63/638,770, filed on Apr. 25, 2024. The disclosure of this prior application is considered part of the disclosure of this application and is hereby incorporated by reference in its entirety.

### FIELD

The present disclosure relates generally to a scrap cutting system, and more particularly, to a scrap cutting system with a moveable enclosure.

### BACKGROUND

This section provides background information related to the present disclosure and is not necessarily prior art.

Steel or other metal scrap in the form of coils, tundishes, and skulls are typically provided in sizes that are too large for the scrap material to be provided to a melting furnace for processing, and therefore, must be cut into reduced sizes prior to feeding into the melting furnace. While scrap metal may be cut manually using a torch, such methods may expose the torch operator to debris. Further, such manual methods require an operator to manipulate or traverse the scrap material during the cutting process, leading to inefficiencies. There is also a concern with yield loss of the material being cut. Cutting such steel scrap with a hand torch or lance pipe creates a very wide “kerf” or cut in the scrap material which is waste or slag material. In addition, the wide “kerf” and the unsteady hand of the operator may increase unwanted smoke and/or fumes released into the atmosphere. Thus, there exists a need in the art for an improved system for cutting scrap metal materials to maximize efficiency and minimize pollution.

### SUMMARY

An aspect of the disclosure provides a scrap cutting system including an enclosure having a first side wall, an opposite second side wall, a first end wall, and an opposite second end wall cooperating to define an interior chamber. The scrap cutting system includes a carriage system supporting the enclosure and configured to translate along a track system and a multi-axis cutting assembly received within the interior chamber of the enclosure. The scrap cutting system further includes an air treatment assembly attached to the enclosure and including at least one intake in fluid communication with the interior chamber.

Aspects of the disclosure may include one or more of the following optional features. In some examples, each of the first end wall and the second end wall include a material opening including a door operable to transition the material opening between an open configuration and a closed configuration. In some implementations, the at least one intake of the air treatment assembly includes a first intake on the first side wall and a second intake on the second side wall. In some configurations, the scrap cutting system has a rail system including a first rail supporting the carriage system at the first side wall of the enclosure and a second rail supporting the carriage system at the second side wall of the enclosure.

In some implementations, the scrap cutting system includes a surveillance system including at least one camera disposed within the interior chamber and viewing the cutting assembly. Optionally, the scrap cutting system includes an operator station attached to the enclosure and including at least one monitor in communication with the surveillance system and configured to receive and display image data from the at least one camera.

In some configurations, the multi-axis cutting assembly is a three-axis cutting assembly including a cutting head attached to a gantry system within the enclosure. Optionally, the cutting head includes a plurality of cutting torches. In some examples, the air treatment assembly includes a first dust collection system attached to the first side wall and including a first intake in communication with the interior chamber through the first side wall, and a second dust collection system attached to the second side wall and including a second intake in communication with the interior chamber through the second side wall.

In some implementations, the carriage system includes a first plurality of wheels arranged in series along one of the first side wall or the second side wall and at least one wheel arranged along the other one of the first side wall or the second side wall, at least one of the wheels is a drive wheel connected to a drive unit. Optionally, at least one of the first plurality of wheels and the at least one wheel are drive wheels.

In some examples, the scrap cutting system includes a fire suppression system in communication with the air treatment assembly.

Another aspect of the disclosure provides a scrap cutting system having a rail system including a first rail, a parallel second rail, and a material staging area disposed between the first rail and the second rail. The scrap cutting system further includes an enclosure supported on the rail system by a carriage and configured to traverse the material staging area and a multi-axis cutting assembly received within the interior chamber of the enclosure above the material staging area. The scrap cutting system further includes an air treatment assembly attached to the enclosure and including at least one intake in fluid communication with the interior chamber.

This aspect of the disclosure may include one or more of the following optional features. In some examples, the enclosure has a first side wall, an opposite second side wall, a first end wall, and an opposite second end wall cooperating to define the interior chamber, each of the first end wall and the second end wall including a material opening including a door operable to transition the material opening between an open configuration and a closed configuration. In some implementations, the at least one intake of the air treatment assembly includes a first intake on the first side wall and a second intake on the second side wall.

In some configurations, the scrap cutting system includes a surveillance system including at least one camera disposed within the interior chamber and viewing the cutting assembly. In some implementations, the scrap cutting system includes an operator station attached to the enclosure and including at least one monitor in communication with the surveillance system and configured to receive and display image data from the at least one camera. In some configurations, the multi-axis cutting assembly is a three-axis cutting assembly including a cutting head attached to a gantry system within the enclosure. Optionally, the cutting head includes a plurality of cutting torches.

### DRAWINGS

The drawings described herein are for illustrative purposes only of selected configurations and not all possible implementations, and are not intended to limit the scope of the present disclosure.

FIG. 1 is a perspective view of an scrap cutting system according to the principles of the present disclosure.

FIG. 2 is a top view of the scrap cutting system of FIG. 1.

FIG. 3 is a side elevation view of the cutting system of FIG. 1.

FIG. 4 is a front elevation view of the cutting system of FIG. 1.

FIG. 5 is a cross-sectional view of the cutting system of FIG. 1, taken along Line 5-5 of FIG. 2.

FIG. 6 is a front perspective view of a carriage assembly of the cutting system of FIG. 1.

FIG. 7 is a bottom view of the carriage assembly of FIG. 6.

FIG. 8 is a bottom view of the carriage assembly of FIG. 6, with certain peripheral subassemblies omitted for clarity.

FIG. 9 is a front perspective view of a cutting assembly of the scrap cutting system of FIG. 1.

FIG. 10 is a rear perspective view of the cutting assembly of FIG. 10.

FIG. 11 is a side elevation view of the cutting assembly of FIG. 10.

FIG. 12 is a front perspective view of an enclosure of the scrap cutting system of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The details of one or more implementations of the disclosure are set forth in the accompanying drawings and the description below. Other aspects, features, and advantages will be apparent from the description, the drawings, and the claims.

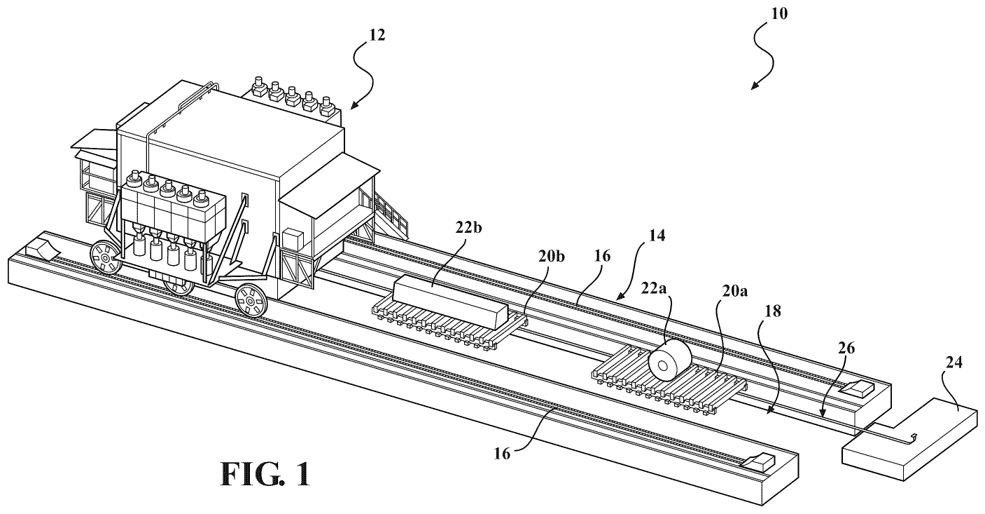

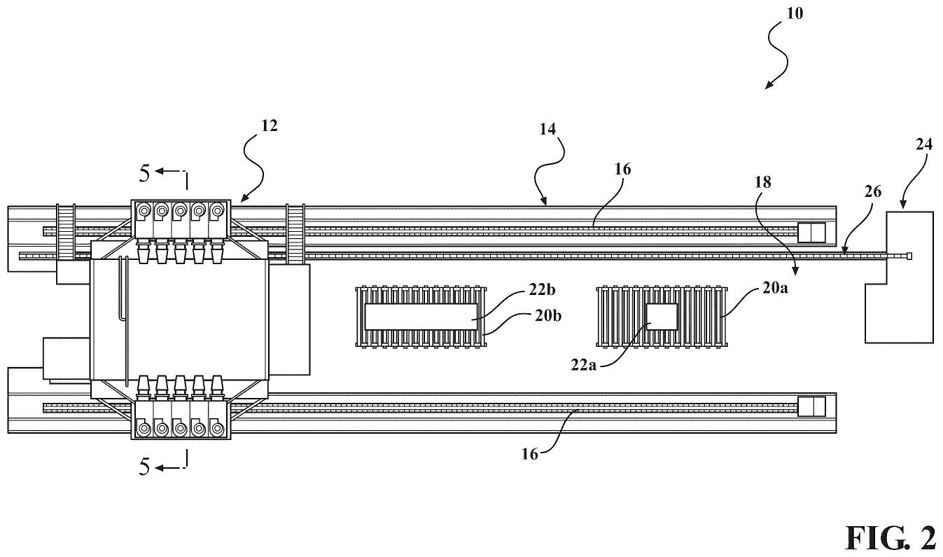

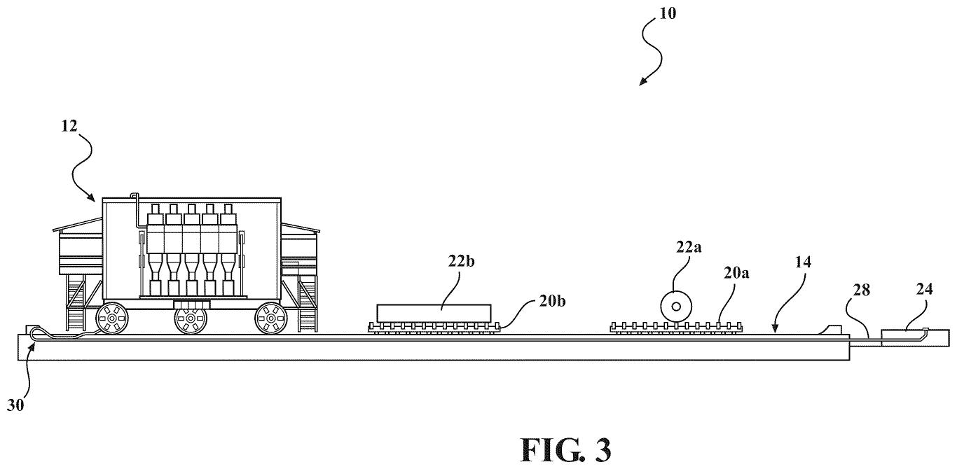

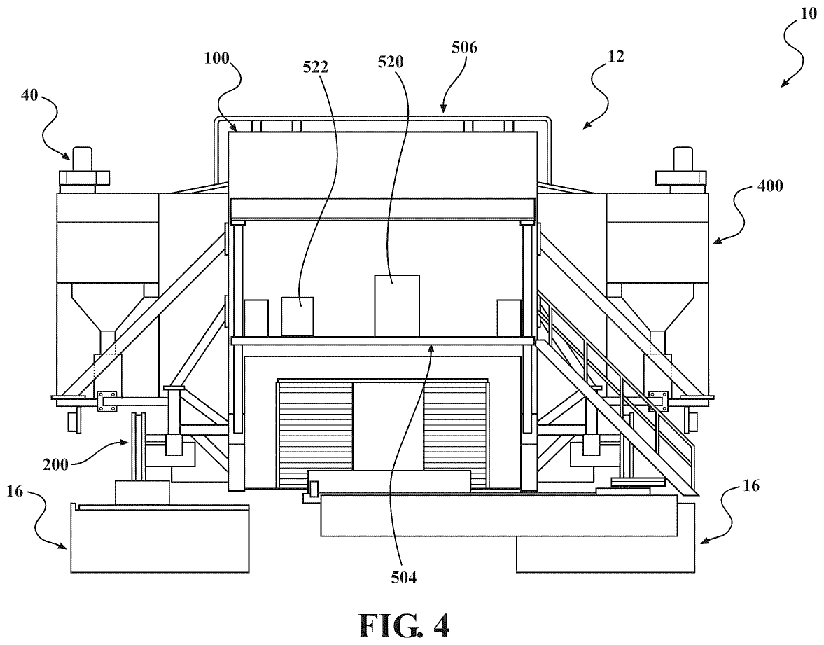

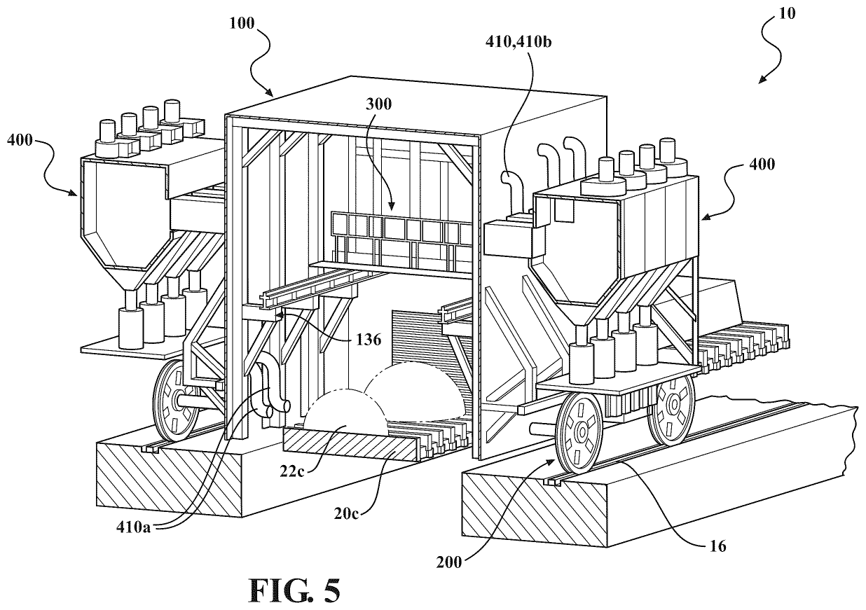

With reference to FIGS. 1-4, an example of a scrap cutting system 10 incorporating the principles of the present disclosure is provided and includes a cutting carriage assembly 12. The cutting carriage assembly 12 is supported on a rail assembly 14 having one or more rails 16 and a material staging area 18. In the illustrated example, the rail assembly 14 includes a pair of parallel rails 16 disposed on opposite sides of the material staging area 18. For example, the material staging area 18 is shown as including a first portion having a first pallet 20, 20a supporting a first material 22, 22a, a second portion having a second pallet 20, 20b supporting a second material 22, 22b within the material staging area 18, and a third portion (FIG. 5) having a third pallet 20, 20c supporting a third material 22, 22c within the material staging area 18 and within the cutting carriage assembly 12. The illustrated pallets 20 and materials 22 are illustrative only and it should be appreciated that different quantities and sizes of pallets 20 may be received in the material staging area 18.

As discussed in greater detail below, the cutting carriage assembly 12 is moveably supported on the rails 16 above the material staging area 18, whereby the cutting carriage assembly 12 is configured to translate along the rail assembly 14 to selectively enclose respective portions of the material staging area 18. For example, while FIG. 5 shows the cutting carriage assembly 12 positioned over the third pallet 20c and the third material 22c, the cutting carriage assembly 12 is configured to translate along the rail assembly 14 to selectively enclose any one of the pallets 20. This configuration allows pallets 20 with materials 22 to be continuously staged in the material staging area 18 outside of the cutting carriage assembly 12 while at least one pallet 20 is being processed (i.e., material 22 is being cut) within the cutting carriage assembly 12. As shown in FIG. 1, the cutting carriage assembly 12 substantially encloses the pallet 20c and material 22c, thereby isolating the processed material 22c and corresponding pollutants (e.g., dust) from the exterior environment.

Referring still to FIG. 1, the scrap cutting system 10 may include a stationary utility hub 24 disposed at one end of the rail assembly 14. The utility hub 24 provides a stationary source for various utilities required to operate the cutting carriage assembly 12, such as electrical service, water service, and various gases, for example. The scrap cutting system 10 includes an extendable utility carrier 26 supporting one or more wires, hoses, or cables between the stationary utility hub 24 and the cutting carriage assembly 12, whereby a fixed end 28 of the utility carrier 26 is disposed at the stationary utility hub 24 and a moveable end 30 of the utility carrier 26 is attached to the cutting carriage assembly 12.

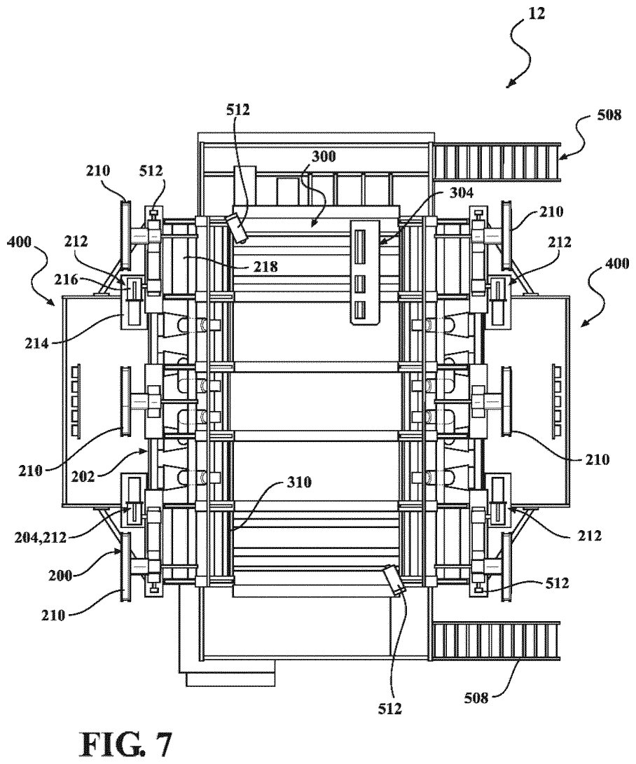

Referring now to FIGS. 5-7, the cutting carriage assembly 12 includes an enclosure 100 defining an interior chamber 102 for receiving the materials 22 during processing. The enclosure 100 is supported on the rail assembly 14 by a carriage system 200. Particularly, the carriage system 200 provides a rolling interface between the enclosure 100 and each of the rails 16 of the rail assembly 14, thereby facility translation of the enclosure 100 and the cutting carriage assembly 12 along the length of the material staging area 18. The cutting carriage assembly 12 further includes a cutting system 300 disposed within the interior chamber 102 and an environmental treatment system 400 in communication with the interior chamber 102. The environmental treatment system 400 is configured to receive potentially contaminated air from within the interior chamber 102 and to clean the air for discharge or recirculation, thereby preventing contaminants associated with the cutting process from entering the environment surrounding the enclosure 100.

The cutting carriage assembly 12 further includes a management system 500 including various peripheral sensors, controls, platforms, and subsystems associated with management and control of the cutting carriage assembly 12. For example, the management system 500 includes an operator station 502 disposed on an exterior of the enclosure 100 and configured for housing one or more operators (i.e., technicians) to monitor and control the cutting carriage assembly 12. The management system 500 may also include a carriage utility platform 504 supporting one or more utilities of the cutting carriage assembly 12. Thus, the cutting carriage assembly 12 may include local utilities (e.g., compressors, fluid coolers, dryers) supported on the enclosure 100 via the carriage utility platform 504 and remote utilities provide to the cutting carriage assembly 12 from the stationary utility hub 24 via the utility carrier 26. The management system 500 may further include a surveillance system including a plurality of cameras 512 arranged within the interior chamber 102 and around an exterior of the cutting carriage assembly 12. The cameras 512 observe respective viewing areas associated with the cutting carriage assembly 12 and convey corresponding image data to one or more display devices (e.g., computer, mobile device, display monitor) (not shown) to allow technicians to remotely monitor conditions in and around the cutting carriage assembly.

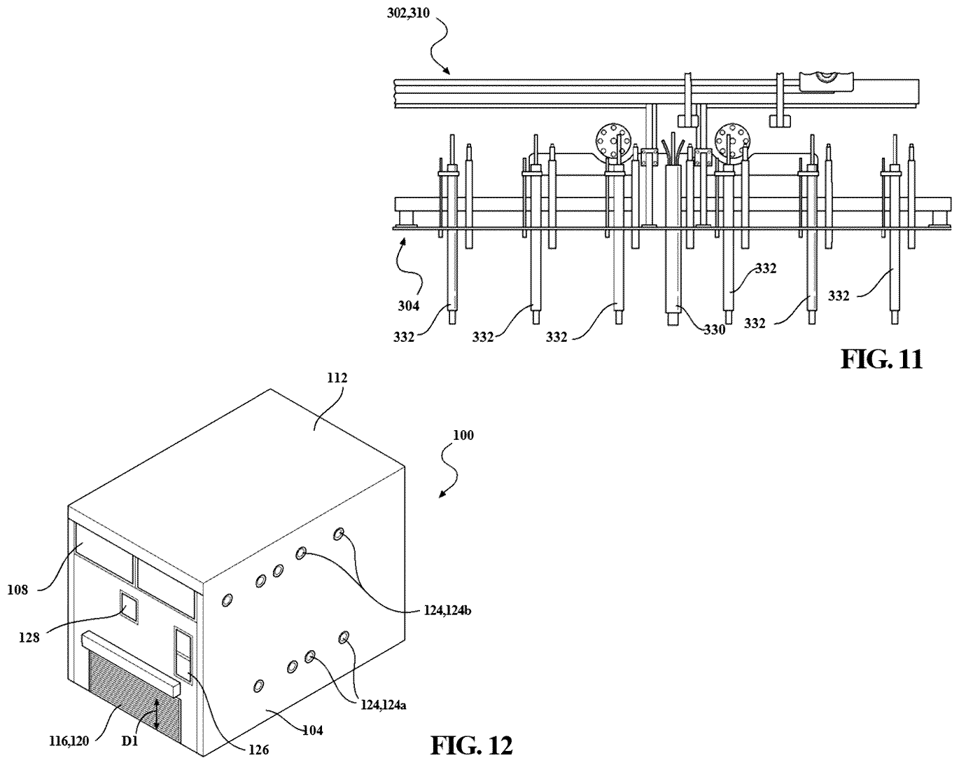

Referring to FIGS. 5-7 and 11, the enclosure 100 includes a walled structure defining the interior chamber 102 and configured to selectively receive and enclose one or more pallets 20 and material 22 for processing by the cutting system 300. The enclosure 100 includes a first side wall 104 and an opposite second side wall 106 spaced apart from the first side wall 104 in a lateral direction to define a width of the interior chamber 102. The enclosure 100 further includes a front end wall 108 and a rear end wall 110 spaced apart from the front end wall 108 along a longitudinal direction to define a length of the interior chamber 102. The end walls 108, 110 extend between the first side wall 104 and the second side wall 106 to enclose opposite ends of the interior chamber 102. A top wall 112 extends between the side walls 104, 106 and the end walls 108, 110 to enclose a top side of the interior chamber 102. As shown, the bottom side of the interior chamber 102 is substantially open and exposed to the material staging area 18. Thus, the side walls 104, 106 of the enclosure 100 straddle the material staging area 18 to receive the pallets 20 and the materials 22 within the interior chamber 102.

Referring still to FIGS. 5-7, the enclosure 100 includes a first material opening 116 formed at bottom edge of the front end wall 108 adjacent to the material staging area 18 and a second material opening 118 formed at a bottom edge of the second end wall 110 adjacent to the material staging area 18. Each of the openings 116, 118 define an unobstructed passage into and through the interior cavity, whereby the pallets 20 and materials 22 can pass into and out of the interior chamber 102 through the openings 116, 118 as the enclosure 100 traverses the material staging area 18. The first material opening 116 includes a first shutter 120 configured to move between an open configuration and a configuration to selectively expose and enclose the interior chamber 102 at the front end wall 108. Similarly, the second material opening 118 includes a second shutter 122 configured to move between an open configuration and a configuration to selectively expose and enclose the interior chamber 102 at the rear end wall 110. The shutters 120, 122 of the present disclosure are configured as roll-up shutters or doors that retract upwardly from the bottom edges of the end walls 108, 110 to selectively move along a vertical direction DI (FIG. 12) to open and close the material openings 116, 118. In use, both shutters 120, 122 may be moved to the open configuration (i.e., retracted) to permit the enclosure 100 to traverse over pallets 20 and materials 22. During processing (i.e., cutting), both shutters 120, 122 may be moved to the closed configuration (i.e., extended) to enclose and isolate the interior chamber 102 from the exterior environment.

Referring still to FIG. 12, each of the side walls 104, 106 includes a plurality of exhaust ports 124 formed through the sidewall into the interior chamber 102. As discussed more below, each exhaust port 124 is configured to receive a corresponding exhaust conduit 410 of the environmental treatment system 400, thereby providing a plurality of intakes for the environmental treatment system 400 within the interior chamber 102. As shown, the exhaust ports 124 include one or more lower exhaust ports 124, 124a arranged along a lower portion of the enclosure 100 adjacent to the material staging area 18. Thus, as shown in FIG. 5, the lower exhaust ports 124, 124a are positioned to maximize airflow intake around the pallet 20c and material 22c during processing, thereby minimizing the amount of cutting debris that circulates within the interior chamber 102. The exhaust ports 124 further include at least one upper exhaust port 124, 124b formed in an upper portion of each side wall 104, 106 adjacent to the top wall. While the lower exhaust ports 124a and the corresponding exhaust ducts 408 collect the cutting debris that settles within the cutting area, the upper cause ports 124b and corresponding exhaust ducts 408 provide supplemental dust collection to capture exhaust and fumes that that rise from the cutting area. The depending on the type of materials being cut and the operating parameters of the cutting system 300, one or more of the exhaust ports 124 may be omitted or shuttered to bias exhaust flow towards the lower exhaust ports 124a or the upper exhaust ports 124b.

Each of the end walls 108, 110 may include various doors and hatches for selective accessing and viewing the interior chamber 102. For example, as shown in FIG. 12, the front end wall 108 includes a first man door 126 for accessing the interior chamber 102 of the enclosure 100 from the carriage utility platform 504. The front end wall 108 may further include a transparent viewing window 128 for viewing the interior chamber 102 from the carriage utility platform 504. Similarly, the rear end wall 110 includes a man door 132 for accessing the interior chamber 102 from the operator station 502 and one or more windows 134, 136 for viewing the interior chamber 102 from the operator station 502. As best shown in FIG. 5, the enclosure 100 includes a mezzanine or catwalk 136 disposed within the interior chamber 102 and accessible from either of the man doors 126, 130. The mezzanine 136 extends at least partially around the interior chamber 102 along the walls 104, 106, 108, 110 and is elevated from bottom of the enclosure 100. The mezzanine 136 provides access to the cutting system 300 within the interior chamber 102 for maintenance and adjustment.

Referring to FIGS. 1-7, the carriage system 200 supports the enclosure 100 on the rail assembly 14 for translation along the material staging area 18. The carriage system 200 includes a chassis system 202 that rollingly supports the enclosure 100 and a drive system 204 that powers movement of the chassis system 202. In the illustrated example, the chassis system 202 includes a first roller assembly 206 attached to the enclosure adjacent to the first side wall 104 and a second roller assembly 206 attached to the enclosure 100 adjacent to the second side wall 104. Each of the roller assemblies 206 includes a roller frame 208 attached to the respective side wall 104, 106 and at least one wheel 210. As shown, each of the roller assemblies 206 includes three wheels 210 arranged in series along each side of the enclosure 100. The wheels 210 are configured to interface with respective ones of the rails 16.

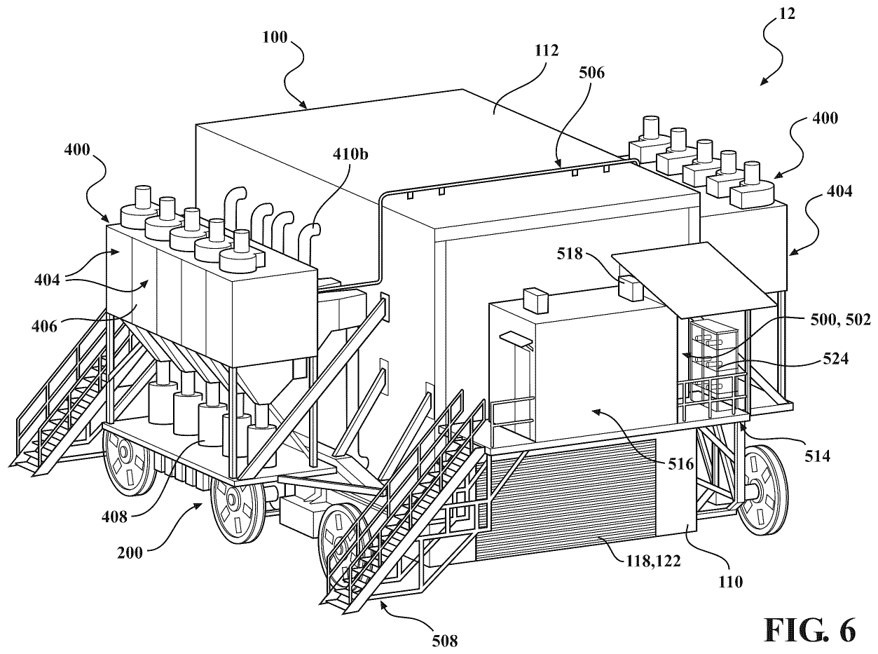

The drive system 204 of the carriage system 200 powers one or more of the wheels 210 to move the enclosure along the rail assembly 14. As best shown in FIG. 6, the drive system 204 includes a plurality of drive units each including a motor 214 and a transmission 216 coupling the motor 214 to an axle associated with one of the wheels 210. While the illustrated example shows the drive units 212 being coupled to axles by a drive chain 218, other configurations may include direct or gear drives. The present disclosure shows drive units 212 connected to the front-most and rear-most wheels 210 on each side, while the middle wheels are free-rolling (i.e., not powered). This configuration provides the cutting carriage assembly 12 with balanced power.

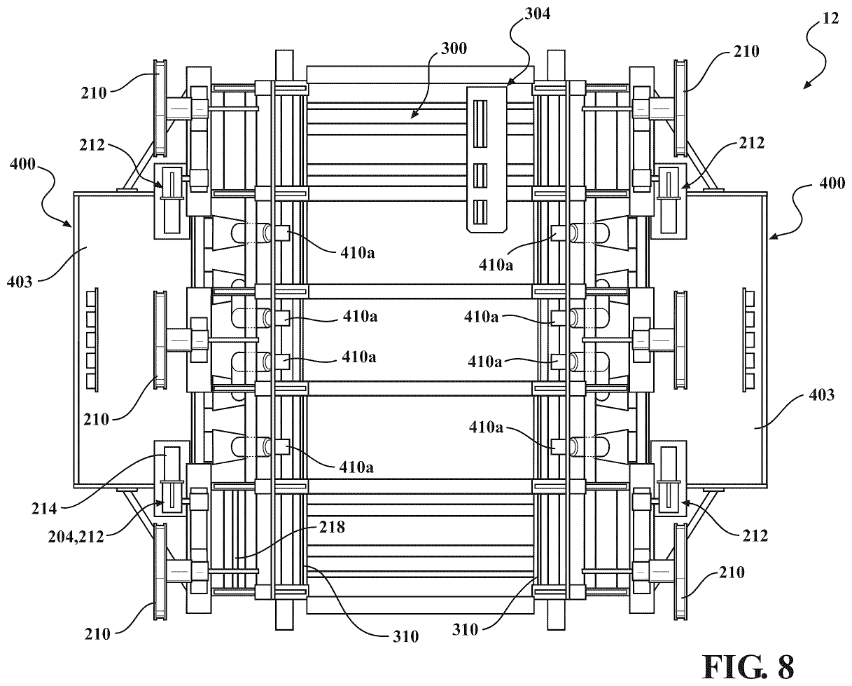

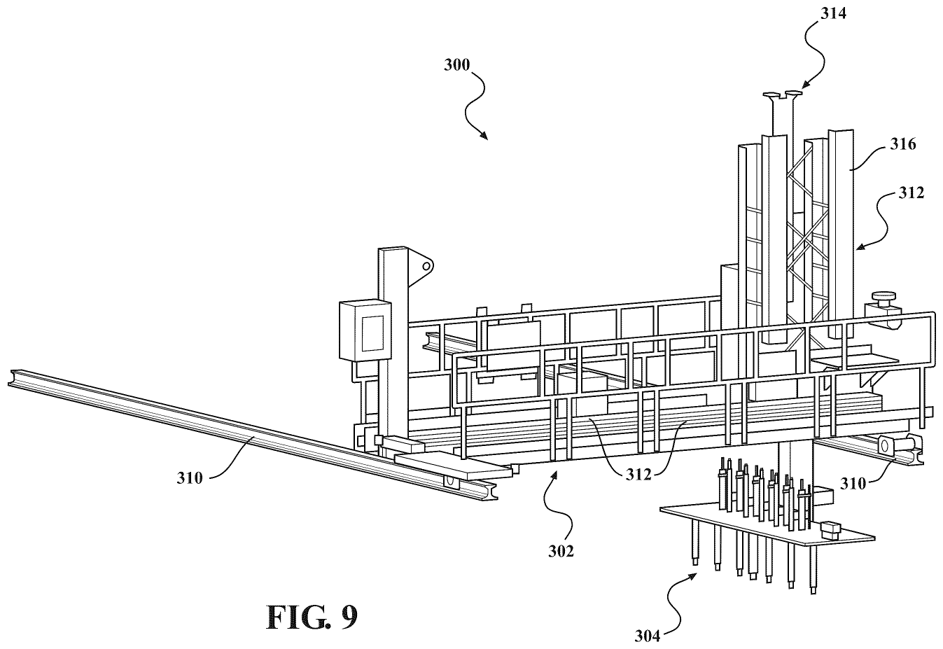

As shown in FIG. 5, the cutting system 300 is disposed within the enclosure and includes a multi-axis cutting system 300 configured to independently traverse the interior chamber 102 to process the material 22. Referring to FIGS. 6-10, the cutting system 300 includes a gantry 302 and a cutting assembly 304 attached to the gantry 302 and configured for three-axis movement within the interior chamber 102. Generally, the gantry 302 facilitates movement of the cutting assembly 304 along two axes (i.e., lateral and longitudinal) within the interior chamber 102, while the cutting assembly 304 itself facilitates movement along a third axis (i.e., vertical) to provide three-axis movement. The gantry 302 includes a pair of longitudinal rails 310 extending along a longitudinal direction of the enclosure 100 (i.e., from front end wall 108 to rear end wall 110) and one or more lateral rails 312 spanning between and connecting the longitudinal rails 310. The one or more lateral rails 312 are configured to translate in the longitudinal direction along the longitudinal rails 310 between the front end wall 108 and the rear end wall 110. The cutting assembly 304 is attached to the one or more lateral rails 312 via a vertical actuator assembly 314 translates in the lateral direction along the one or more lateral rails 312. The vertical actuator assembly 314 includes one or more vertical rails 316 and a vertical actuator 318 for supporting and moving the cutting assembly in the vertical direction relative to the gantry 302. The cutting system 300 may further include a platform 318 for supporting one more personnel.

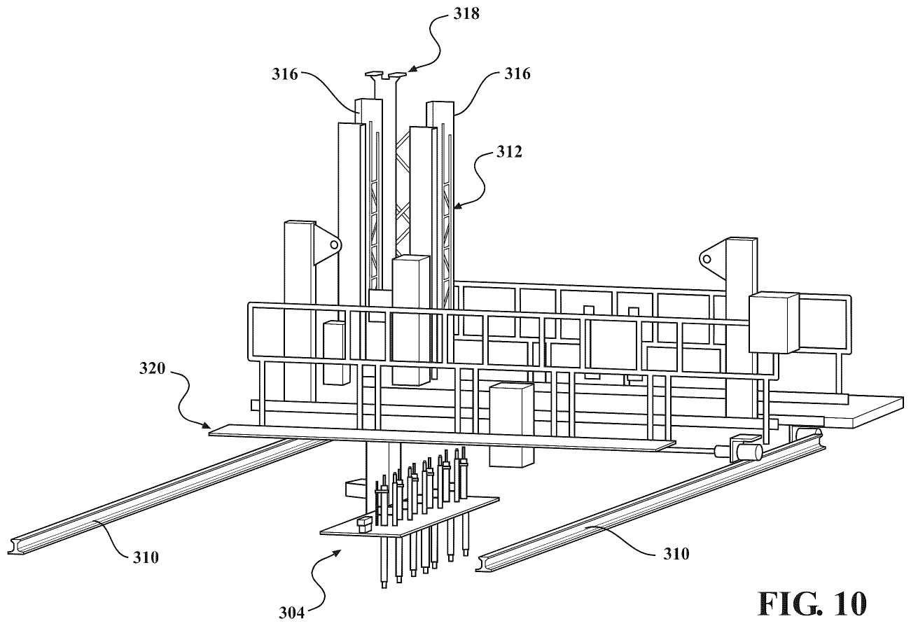

With reference to FIG. 10, the cutting assembly 304 includes a plurality of torch assemblies 330, 332 including one or more primary torch assemblies 330 and one or more secondary torch assemblies 332. In the illustrated example, the cutting assembly 304 includes one primary torch assembly 330 configured to cut materials 22 having a first thickness and a plurality of secondary torch assemblies 332 configured to cut materials 22 having a second thickness that is less than the first thickness. For example, the primary torch assembly 330 may be designed to cut materials having a thickness greater than 800 mm and the secondary torch assemblies 332 may be designed to cut materials having a thickness less than 800 mm. Primary torch assemblies 330 and secondary torch assemblies 332 may be selected based on the materials 22 to be processed. Examples of suitable primary torch assemblies 330 include MDZ2053 torches offered by Donze™ Examples of suitable secondary torch assemblies 332 include MDZ1053 torches offered by Donze™.

With continued reference to FIGS. 1-7, the environmental treatment system 400 is integrated with the enclosure 100 to continuously clean exhaust air from within the interior chamber 102. The environmental treatment system includes a pair of air treatment systems 402 each supported by a respective support frame 403 on opposite sides of the enclosure 100. As shown, a first one of the air treatment systems 402 is supported along the first side wall 104 and includes a first series of air handling units 404 each including an air separation module 406 and a collection module 408. The separation modules 406 may include a dust collection system including various forms of filters for separating dust and other pollutants from exhaust air received from the interior chamber 102. One example of a suitable air handling unit 404 includes a GSX8 Gold Series™ dust collector offered by Camfil™.

In the illustrated example, each air treatment system 402 includes five air handling units 404, with each air handling unit 404 in communication with the interior chamber 102 of the enclosure through an exhaust conduit 410 connected to a respective one of the exhaust ports 124, 124a, 124b discussed previously. Thus, as discussed above, the first air handling system 402 on the first side of the enclosure 100 includes four air handler units 404 configured to intake air from the interior chamber 102 via the lower exhaust ports 124a arranged along the lower portion of the first side wall 104 and one air handler unit 404 configured to intake air from the interior chamber via the upper exhaust port 124b arranged in the upper portion of the first side wall 104. Likewise, the second air handling system 402 on the second side of the enclosure 100 includes four air handler units 404 configured to intake air from the interior chamber 102 via the lower exhaust ports 124a arranged along the lower portion of the second side wall 106 and one air handler unit 404 configured to intake air from the interior chamber via the upper exhaust port 124b arranged in the upper portion of the second side wall 106. This configuration maximizes air filtration along the lower portion of the enclosure 100 associated with the cutting process, while still providing supplemental filtration to the upper portion of the enclosure.

The management system 500 includes various controls and peripherals for operating the cutting carriage assembly. With reference to FIG. 5, the operator station 502 is supported along the rear end wall 110 of the enclosure 100 and includes an operator platform 514 positioned above the second material opening 118, whereby materials 22 can pass below the operator station 502 as the cutting carriage assembly 12 traverses the material staging area. The operator platform 514 extends along and provides access to the second man door 130. A staircase 508 is positioned at a first side of the operator platform 524 and provides access from the ground level. The operator station 502 further includes an operator cabin 516 supported on the operator platform 514 above the second material opening 118 and adjacent to a first one of the windows 132. The operator cabin 516 is configured to house one or more technicians and a control system (not shown), which may include various monitoring systems, displays, and controllers for viewing image data received from the cameras 512 and for controlling movement and operation of the cutting system 300. Optionally, the operator cabin 516 may include a climate control system 518.

Referring to FIG. 6, the carriage utility platform 504 is supported at the front end wall 108 of the enclosure 100 and includes various utilities and peripherals for operating the cutting carriage assembly. As shown, the carriage utility platform 504 includes an compressed air system 520 that provides compressed air to the various operating systems 200, 300, 400 of the cutting carriage assembly 12 and a liquid cooling system 522 (e.g., water/glycol cooling system) to provide hydraulic utilities to the various operating systems 200, 300, 400. The cooling system 522 provides a continuous flow of cooled fluid to each of the cutting system 300 for cooling the torch assemblies 330, 332 and to the cameras disposed within the interior chamber 102. The compressed air system 520 provides blast air to each of the air handling units 404 and the cameras 512 to clear debris from the respective motors and/or lenses.

The management system 500 further includes a gas management system 524 supported on the operator platform 514 adjacent to the operator cabin 516. The gas management system 524 is in communication with controllers of the operator cabin 516 and includes a plurality of regulators, valves, and other control systems for regulating flow of gases to the cutting system 300 within the enclosure 100. While the gas management system 524 is provided on the operator platform 514, the gas management system 524 may be incorporated on the carriage utility platform 504 with the other utilities.

Optionally, the management system 500 may include a fire suppression system 506 including one or more fire suppressant dispensers configured to dispense a fire suppressant to the air treatment system 402. The fire suppression system 506 may include an inert gas suppression system or other type of system having a first dispenser configured to emit a fire suppressant at the first air treatment system 402 and a second dispenser configured to emit a fire suppressant at the second air treatment system 402. Further, the fire suppression system 506 may include one or more dispensers within the enclosure 100 configured to emit fire suppressant to a cutting area associated with the cutting system 300.

The terminology used herein is for the purpose of describing particular example configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A scrap cutting system comprising:
an enclosure having a first side wall, an opposite second side wall, a first end wall, and an opposite second end wall cooperating to define an interior chamber;
a carriage system supporting the enclosure and configured to translate along a track system;
a multi-axis cutting assembly received within the interior chamber of the enclosure; and
an air treatment assembly attached to the enclosure and including at least one intake in fluid communication with the interior chamber.

2. The scrap cutting system of claim 1, wherein each of the first end wall and the second end wall include a material opening including a door operable to transition the material opening between an open configuration and a closed configuration.

3. The scrap cutting system of claim 1, wherein the at least one intake of the air treatment assembly includes a first intake on the first side wall and a second intake on the second side wall.

4. The scrap cutting system of claim 1, further comprising a rail system including a first rail supporting the carriage system at the first side wall of the enclosure and a second rail supporting the carriage system at the second side wall of the enclosure.

5. The scrap cutting system of claim 1, further comprising a surveillance system including at least one camera disposed within the interior chamber and viewing the cutting assembly.

6. The scrap cutting system of claim 5, further comprising an operator station attached to the enclosure and including at least one monitor in communication with the surveillance system and configured to receive and display image data from the at least one camera.

7. The scrap cutting system of claim 1, wherein the multi-axis cutting assembly is a three-axis cutting assembly including a cutting head attached to a gantry system within the enclosure.

8. The scrap cutting system of claim 7, wherein the cutting head includes a plurality of cutting torches.

9. The scrap cutting system of claim 1, wherein the air treatment assembly includes a first dust collection system attached to the first side wall and including a first intake in communication with the interior chamber through the first side wall, and a second dust collection system attached to the second side wall and including a second intake in communication with the interior chamber through the second side wall.

10. The scrap cutting system of claim 1, wherein the carriage system includes a first plurality of wheels arranged in series along one of the first side wall or the second side wall and at least one wheel arranged along the other one of the first side wall or the second side wall, at least one of the wheels is a drive wheel connected to a drive unit.

11. The scrap cutting system of claim 10, wherein at least one of the first plurality of wheels and the at least one wheel are drive wheels.

12. The scrap cutting system of claim 1, further comprising a compressor platform attached to an exterior of the enclosure.

13. The scrap cutting system of claim 1, further comprising a fire suppression system in communication with the air treatment assembly.

14. A scrap cutting system comprising:
a rail system including a first rail, a parallel second rail, and a material staging area disposed between the first rail and the second rail;
an enclosure supported on the rail system by a carriage and configured to traverse the material staging area;
a multi-axis cutting assembly received within the interior chamber of the enclosure above the material staging area; and
an air treatment assembly attached to the enclosure and including at least one intake in fluid communication with the interior chamber.

15. The scrap cutting system of claim 14, wherein the enclosure has a first side wall, an opposite second side wall, a first end wall, and an opposite second end wall cooperating to define the interior chamber, each of the first end wall and the second end wall including a material opening including a door operable to transition the material opening between an open configuration and a closed configuration.

16. The scrap cutting system of claim 15, wherein the at least one intake of the air treatment assembly includes a first intake on the first side wall and a second intake on the second side wall.

17. The scrap cutting system of claim 14, further comprising a surveillance system including at least one camera disposed within the interior chamber and viewing the cutting assembly.

18. The scrap cutting system of claim 17, further comprising an operator station attached to the enclosure and including at least one monitor in communication with the surveillance system and configured to receive and display image data from the at least one camera.

19. The scrap cutting system of claim 14, wherein the multi-axis cutting assembly is a three-axis cutting assembly including a cutting head attached to a gantry system within the enclosure.

20. The scrap cutting system of claim 19, wherein the cutting head includes a plurality of cutting torches.
